(19) United States
(12) Patent Application Publication
(10) Pub. No.: US 2018/0374137 A1
(43) Pub. Date: Dec. 27, 2018

(54) ONLINE GARMENT DESIGN AND COLLABORATION SYSTEM AND METHOD

(71) Applicant: Iva Sareen, Rolling Hills, CA (US)

(72) Inventor: Iva Sareen, Rolling Hills, CA (US)

(21) Appl. No.: 16/016,351

(22) Filed: Jun. 22, 2018

Related U.S. Application Data
(60) Provisional application No. 62/523,754, filed on Jun. 22, 2017.

(51) Int. Cl. G06Q 30/06

(52) U.S. Cl. CPC G06Q 30/0621; G06Q 30/0613; G06Q 30/0633

(57) ABSTRACT

A server system and method is for facilitating garment creation. A processor and storage device are configured to receive and store designed digital garment or garment parts for selection, approval and/or inclusion into a digital garment. A designer interface is accessible over a network and is configured to view, approve, select and place two or more of the digital garment parts together to form a digital garment to store in the storage device. An online purchase system is configured to access the storage device to select and purchase the digital garment from a plurality of available digital garments.

### RELATED APPLICATION INFORMATION

This Application claims the benefit of U.S. Provisional Patent Application Ser. No. 62/523,754, entitled “Online Garment Design and Collaboration System and Method”, filed on Jun. 22, 2017, the contents of which are incorporated herein in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to an online garment design system and method.

### BACKGROUND OF THE INVENTION

It is typical in the fashion design industry to produce a sample garment from a design sketch almost entirely by hand. To produce a sample garment, a complete garment pattern is created from a design sketch, and then pattern pieces representing the individual parts comprising the garment are cut from paper, cardboard or plastic. Once the pattern pieces are cut, they are arranged on the fabric or other sheet material from which the garment is to be made and are used as templates for cutting the corresponding garment parts from the sheet material. The garment parts are then sewn or otherwise assembled to form the sample garment.

This is both a time consuming and expensive procedure, since it takes even highly skilled workers a considerable amount of time to create an overall garment pattern from the design sketch, cut the pattern pieces for the individual garment parts comprising the garment, arrange the pieces properly on the sheet material and then accurately cut the individual garment parts from the material. The skill level required to arrange the cut pattern pieces is higher still where the garment is cut from plaid, stripped, checked or other patterned sheet material, since the pattern pieces must be accurately positioned on the material to insure that the pattern in the material properly matches after the garment parts cut from the material are assembled.

Once the sample garment is cut and assembled, it is critically reviewed by the designer to determine if the garment accurately reflects the underlying design. Usually, modifications to the overall shape of the sample garment or to particular garment parts are required before the designer is satisfied that the garment accurately embodies what was intended in the design sketch. In addition, the designer may want to see sample garments made from several different materials or from materials having different patterns. Further, the designer may wish to try different sleeve lengths, top-bottom configurations, or the like. Accordingly, it is often the case that many different sample garments must be cut and assembled before a particular fashion design is finalized.

Sampling is very important for garments manufacturing process in the textile industry. The process of sampling varies from context to context, and the development process covers a wide range of diverse products from new fibers, fiber blends, new yarns, fabric structures, finishes and surface effects and all types of made up products such as knitwear, hosiery, cut and sewn garments, household products, technical and medical products. There are different phases of sampling; the first phase covers the development of the initial concept or design idea through its approval by the customer and full review/risk analysis by the development and production teams. The second phase covers the process following acceptance of the first prototype sample and includes the functions of sourcing and ordering component, testing the product and carry out trails once the finalized sample specifications has been drawn up, the third and final phase commences. The phase includes a range of activities that are carried out before large scale or bulk production capacity outside the home producer/developers wherever this is applicable.

### Development or Enquiry Samples

Vendors (designers or design companies) work with some buyers continuously. They have to keep on sending samples to buyers very often. Whenever they have enquiries, a buyer may need samples. Buyers may like to see the garments in a new fabric. For one enquiry, they may need samples in different fabrics to choose from. If they want to develop new style in new fabric, then also we will have to send these samples.

Vendors may have to expend a lot of time and resources on these samples. But these samples are inevitably important to develop business. Sometimes, even the buyer is not so confident of some enquiries. If a vendor's samples are attractive at reasonable prices, they will receive orders from buyers.

Also vendors will have to send samples to the newly contacted buyers to show their workmanship, product range, quality standards and price level.

### Salesmen Samples or Promotional Samples

Some buyers need these samples for getting the orders from their customers. If the buyer has 7 salesmen in his office, then the buyer will ask the vendor to make 7 samples in each style. The salesmen will book the orders from their customers by showing these samples.

If a vendor sends samples for 5 styles, sometimes, the vendor may get orders for all 5 styles, 3 styles or 1 style. Sometimes, a vendor may not get an order for even a single style. Expected sales may not occur due to poor quality, unsuitable colors, improper measurements, unmatched prints or embroidery, etc., of salesmen samples. Or it may be due to a local business recession, competition or unsuitable prices. Anyway, a vendor has to make these salesmen samples perfectly with sincere interest to get orders.

### Photo or Fit Samples

Photo or fit samples are to be made after getting the order sheets. These samples are needed to check the measurements, style and fit. Some buyers may need these samples if they want to print the photos of garments on photo inlays, packing boxes, hang tags, etc. These samples may be needed for local advertisement or a buyer's promotional occasions.

In any cases, the samples will be worn by the highly paid models. The buyers will arrange expensive photo shoot sessions with advertising agencies. Thus, the buyers will need these samples in a timely manner. Delays may be expensive for the buyers.

### Counter Samples or Reference Samples or Approval Samples

These samples are made in the actual fabrics with actual trims. If the order is for 3 colors, the buyer may need samples in any one color and swatches (fabric bits) in other colors. These samples should be strictly as per the specifications in the order sheets. The vendor has to get the approval for these samples from the buyer before starting production.

After getting the approval, the approved samples should be followed in production. Sometimes, the buyer may comment on fabric, measurements, making, etc. The vendor has to follow these comments carefully in production.

The order sheets may be subject to the approval of counter samples. Thus, these samples are very important.

### Wash Test Samples

Wash test samples are sent before starting production and if vendors get some remarks or comments on these samples, they can correct them in production. But some buyers will need vendors to send these samples from production before shipment. In this case, these samples may be considered as ‘shipment samples’.

### Pre-Production Samples

These samples are almost like approval samples. They have to be made in actual production fabric with actual bulk trims. They will represent the actual garments.

### Production Samples

Production samples are to be sent before shipment to get the buyer's confirmation for shipment. Hence these samples need to be perfect in all manners. Buyers may check these samples for everything or anything.

### Shipment Samples

Shipment samples are to be sent after shipment. They are usually sent in actual packing with all labels, tags, etc.

The above described process can be expensive, time consuming, and may suffer from a lack of, or incomplete, communications. Thus, a system and method for online garment design and collaboration is needed.

### SUMMARY OF THE INVENTION

In accord with a preferred embodiment, a server system for facilitating garment creation, comprises: a processor and storage device configured to receive and store designed digital garment parts for selection and inclusion into a digital garment; a designer interface accessible over a network configured to select and place two or more of the digital garment parts together to form a digital garment to store in the storage device; and an online purchase system configured to access the storage device to select and purchase the digital garment from a plurality of available digital garments. The server system may include at least one or more of the digital garment parts are capable of being designed using the designer interface. The server system may be capable of receiving at least one or more of the digital garment parts by upload from a third-party design system. The server system may further include an interface for providing approval for the digital garment for manufacture or sale. The online purchase system may further be configured to provide designers with the ability to purchase the digital garment parts to include in the digital garment. The online purchase system may comprise a pay-per-part system or a subscription system.

In accord with another preferred embodiment, a method for facilitating garment creation comprises: receiving and storing designed digital garment parts for selection and inclusion into a digital garment; selecting and placing two or more of the digital garment parts together to form a digital garment to store in the storage device; and providing an online purchase system configured to access the storage device to select and purchase the digital garment from a plurality of available digital garments.

### BRIEF DESCRIPTION OF THE DRAWINGS

FIG. 1 is a network diagram that illustrates the flow of data between designers, vendors, buyers, and manufactures for facilitating design and exchange of samples, comments, and acceptance according to one embodiment;

FIG. 2 is a diagrammatic representation of a cloud storage system having a database of available garment parts, textures, patterns, and colors that are available for designing, assembling, and creating garments;

FIG. 3 is a flow diagram that illustrates steps performed on a processor for creating a virtual garment from virtual parts in the system;

FIG. 4 is a flow diagram that illustrates the steps performed by the system for allowing a designer to create a design from garment parts;

FIG. 5 is a sample screen presented by the development software for creating a garment;

FIG. 6 is a sample screen presented by the development software for adding patterns to the garment; and

FIG. 7 is a sample screen presented by the development software for scaling patterns for the garment.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

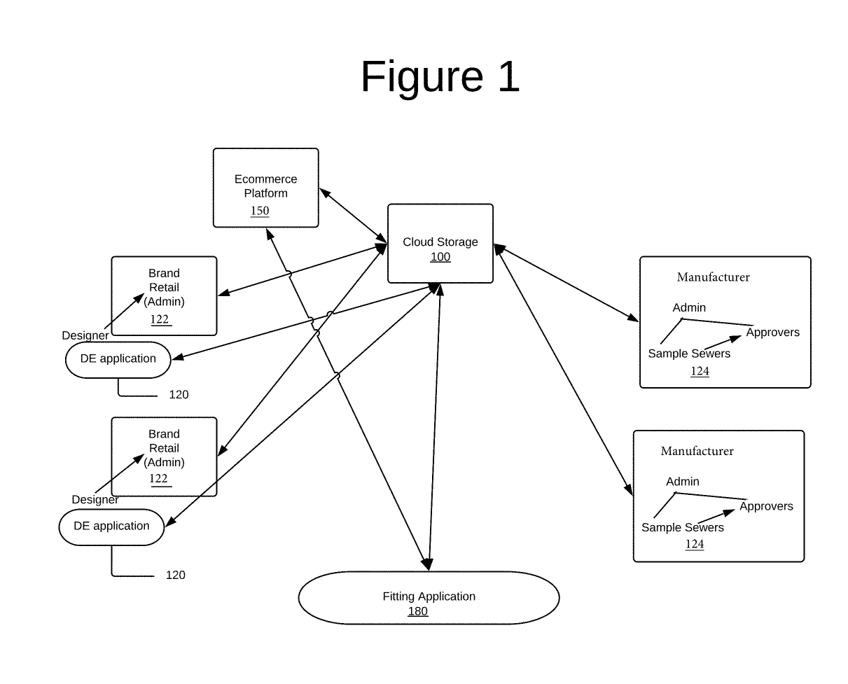

The system for an online garment design system and method is disclosed in accordance with preferred embodiments of the present invention is illustrated in FIGS. 1-7 wherein like reference numerals are used throughout to designate like elements.

With reference to FIG. 1, a network diagram illustrates the flow of data between designers, vendors, buyers, and manufactures for facilitating design and exchange of samples and comments, and acceptance. A cloud storage server 100 provides a central storage and access to all of the parties involved in the system. In one embodiment, the processing of creating pieces to a garment may start with a designer using one or more design applications 120 on one or more electronic devices, such as a high-end personal computer or workstation.

For example, and not by way of limitation, it is more likely in some embodiments that clothing manufactures 124 or retailers 122 would provide specifications for the apparel that may or may not include a digital or paper pattern.

From the digital pattern production sample garment, technical pack, grading rules, fit model scan data or body measurements, digital pattern pieces are created, or converted from a digital pattern, using the apparel product development software 120. Generally, a pattern refers to the collection of the individual pieces of the garment. In standard practice, the pattern pieces are drafted first, then laid over fabric, which is then cut around the perimeter of each piece. The resulting pieces of fabric are then sewn (virtually) together to form the finished digital garment. Therefore, the pattern refers to a blueprint of the garment and its individual pieces. However, in one embodiment, all of the steps are done digitally.

Indeed, there are several cases in which a digital pattern is received, made, or modified from the above-referenced information received from the retailer. In one embodiment, part of the apparel product development software 120 may include a software program named TUKACAD running on product development workstation in the 3D virtual apparel processing system, which may be used to create or reformat the digital pattern. TUKACAD is widely used CAD software for digital pattern making, digitizing, grading, and marker making in the apparel industry, and is available from TUKATech, Inc. of Los Angeles, Calif., www.tukatech.com. TUKACAD creates points and interpolates splines between points to create a 2D shape or CAD drawing. Additionally, the digital pattern can be graded in TUKACAD to create larger or smaller sizes. Those skilled in the art would recognize that a variety of CAD software programs may be used to perform the functions carried out by TUKACAD, but TUKACAD has features that those of skill in the art recognize as unique.

As noted above, there are several cases regarding the kind of information that is received from a retailer regarding a production sample garment from which the digital pattern pieces are created in TUKACAD. Retailers may provide or utilize a widely used technical pack with specifications for how the style is to be made and/or may provide or use a production sample garment for reference. These instructions are then interpreted in the software 120 to create a digital pattern.

For use of a paper pattern for corresponding to production sample garment pieces, the paper pattern may then be digitized or scanned into TUKACAD software using digitizer or pattern scanner. As the paper pattern is being digitized, TUKACAD software draws the pattern in digital form resulting in a digital pattern made of digital pattern pieces.

In another case, the retailer may have a digital pattern in a third-party format. The digital pattern may then be converted into the format that can be read by the apparel product development software 120 using built-in conversion tools in TUKACAD Software.

In one embodiment, the development software 120 named E-FIT SIMULATOR, also called E-FIT herein, is used as the computer model. E-FIT SIMULATOR is commercially available from TUKAtech, Inc. of Los Angeles, Calif., www.tukatech.com, and is built using 3DS MAX's SDK. E-FIT, in one embodiment, incorporates cloth simulation plug-in software, CLOTHFX, which is manufactured by Size 8 Software, and is readily available from TurboSquid, Inc. of New Orleans, La., www.turbosquid.com. E-FIT may be used in conjunction with the aforementioned CLOTHFX software to create 3D virtual apparel, including draping on a virtual model and simulating animation in a 3D environment as described below. This combination of software is currently used commonly by designers and engineers for rapid prototyping of apparel design and development.

Once the garment part is completed, it may be uploaded to the cloud storage 100 for storage in the database of garment parts. The online storage allows for instant access to the rest of the stakeholders in the system, including administrative staff, who may be with, for example, the garment manufacturer 124 and/or sewers who may be, for example, also employed by the manufacturer 124. Instead of having to receive digital or physical files, the stakeholders merely need to access the garment part stored in the cloud storage 100, for example, through a secure connection over the internet. This method saves time, and provides for a central location for garment part access.

Once the part is approved, the garment part is marked as publicly viewable and purchasable via an ecommerce system 150. The ecommerce system may be accessed by any entity who is in the business of purchasing garment parts for digitally stitching with other garment parts to create whole digital garments.

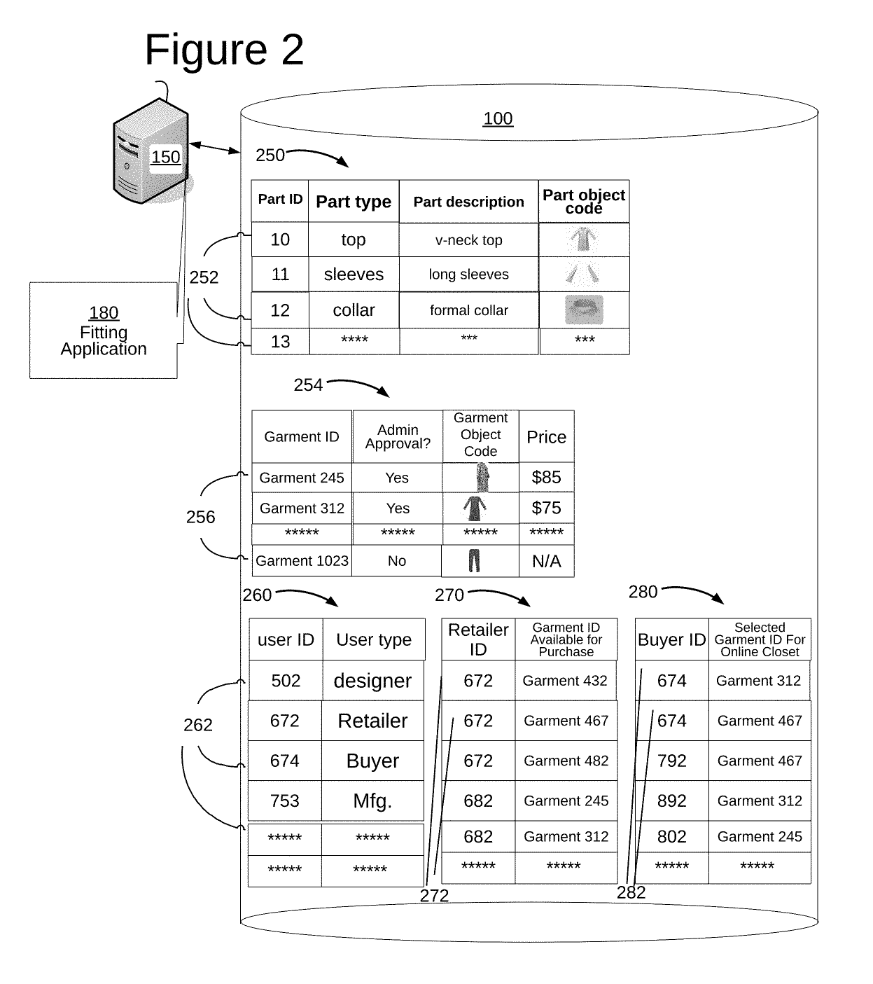

With reference to FIG. 2, the cloud storage system 100 having a database of available garment parts, textures, patterns, and colors that are available for designing, assembling, and creating garments is shown. In one embodiment, each of the garment parts, textures, patterns, and colors are stored in a garment part table 250 in the database 100. These parts were may have been created and stored in the part table 250 by creators and copyright holders of those parts, textures, patterns, and colors. They may each be subscribed to, paid for, and utilized by the entities in FIG. 1 to build garments. Then the samples may be exchanged and commented on by the various entities from design to production.

In one embodiment, each database record 252 in table 250 may have fields for a part identifier (ID), part type, part description, and object code representing graphic, technical, and metadata for the garment part for that record. Designers may either upload parts to the database, or purchase and download parts to make garments. The garments created using the parts from table 250 may also be stored as full garments in a garment table 254. The parts may be purchased using the ecommerce system 150 in communication with the cloud storage system 100. The designer may get parts of garments from the cloud storage 100 (or third party garment parts storage, or historic data), mix and match, attach, and then, use the parts to create a new design.

In one embodiment, the administrative staff of manufacturers or other entities may then login through either the cloud storage system 100 or the ecommerce system 150 to approve garments pieced together by the designers. The garment table 254 may, by way of example, contain records 256, wherein each record has a garment ID, admin approval field, the object code for the garment comprising graphic, technical, and metadata for the stitched together pieces, and a price or suggested price for purchase of the garment through the ecommerce system 150.

After creation of the garment, the designer may then send the virtual garment he or she designed to the cloud storage system 100 for download by the manufacturer 124, or directly to the manufacturer 124 so that the manufacturer 124 may use the design to create a virtual sample for approval and trying on virtual garments of different sizes on virtual fit models created using a fitting application (180 in FIG. 1). An example of a fitting application 180 is described in pending U.S. patent application Ser. No. 13/159,401.

Other tables in the cloud storage system 100 may include, for example, a user database 260, that may contain records 262 relating to user information. For example, each record 262 may include a user identifier (ID), and the type of user for the record (e.g. designer, retainer, buyer, manufacturer).

Another retailer table 270 may contain records 272 for keeping track of the garments in the garment table 254 that are available for sale by each retailer. Each record 272 in the retainer table 270 may contain the retainer's user ID and one or more garments that are for sale in the garment table 254.

Finally, a buyer table 280 may keep track of garments purchased by each buyer using the ecommerce system. Each record 282 of the buyer table 280 may contain, for example, the user ID for each buyer, and the garment ID for each garment in table 254 purchased by the buyer.

The sample approval process may go back and forth. Once ready production, all sizes of the virtual garment may be uploaded to the cloud system 100 or the brand's website to facilitate ecommerce transactions. The ecommerce customer may then create an avatar using the online fitting application 180, and try on the virtual garment from the ecommerce site or the cloud. An example of such a virtual trial system is disclosed in U.S. Pending patent application Ser. No. 13/159,401, which is hereby incorporated by reference in its entirety.

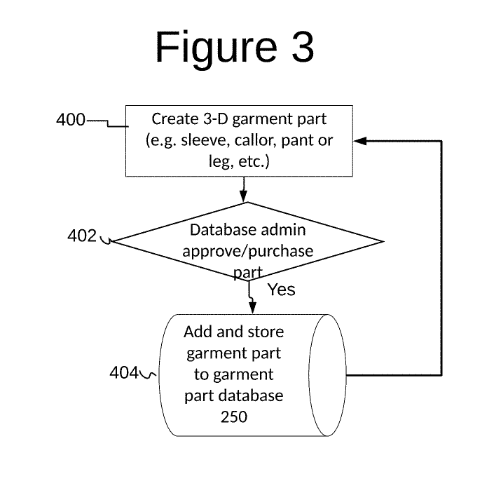

With reference to FIG. 3 a flow diagram illustrates steps performed on a processor for creating a virtual garment from virtual parts in the system. In step 400, a designer may use the developer software 120 to create a garment part. In some embodiments, the garment part is stored in table 250, but not published for purchase until approval. In step 402, an administrative staff member may approve the publishing of the garment from table 250 for sale or use by designers to create a garment, step 404.

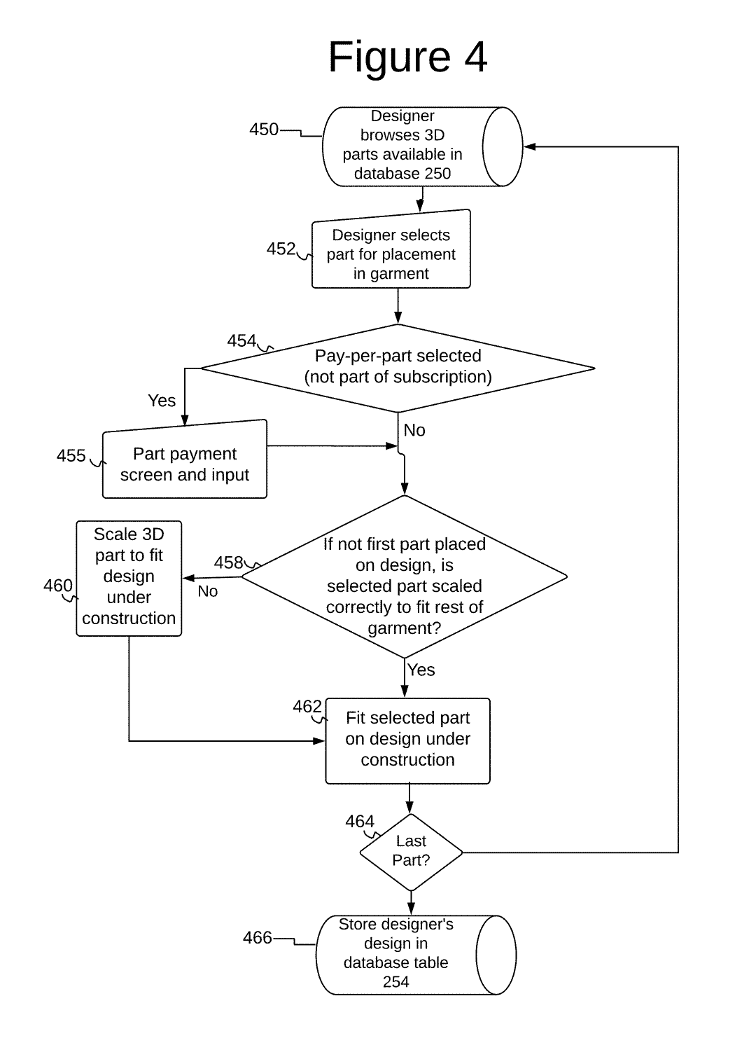

With reference to FIG. 4, a flow diagram illustrates the steps performed by the system for allowing a designer to create a design from garment parts. In step 450, a designer may browse the parts from the table 250, or other third party parts, for use in creating a garment. In step 452, the designer may select a part to include in the garment. In step 454, the system determines whether the part selected is one for which the designer must pay (either on a per-part bases or as part of a designer's subscription). If so, the ecommerce system 150 completes the payment procedure in step 455.

Next, in step 458, if the currently selected part is not the first part selected for the garment, the system determines whether the part selected is scaled correctly for the garment being built. If not, then in step 460, the selected part is scaled to fit the garment under construction. In step 462, the selected part is fitted to the garment under construction.

If the selected part that was fitted is not the last part (step 464), then processing moves back to step 450 to allow the designer to choose another part for the garment. Otherwise, after the last part, then in step 466, the finished garment may be stored in the garment table 254 to wait for approval by admin before publishing for purchase through the ecommerce system 150.

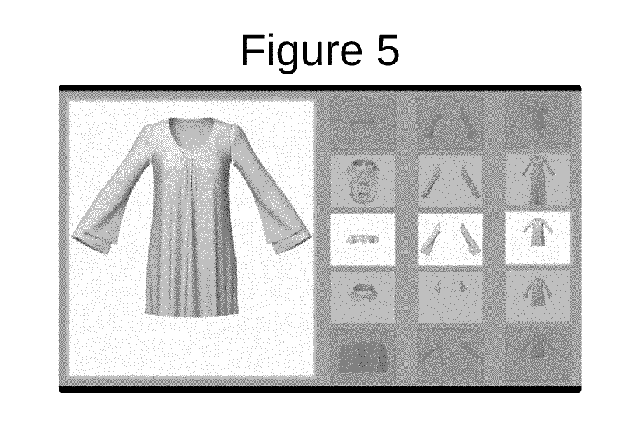

With reference to FIG. 5, a sample screen presented by the development software 120 for creating a garment is shown. The designer may drag and drop garment parts from the right side of the screen onto the garment being built on the left side of the screen.

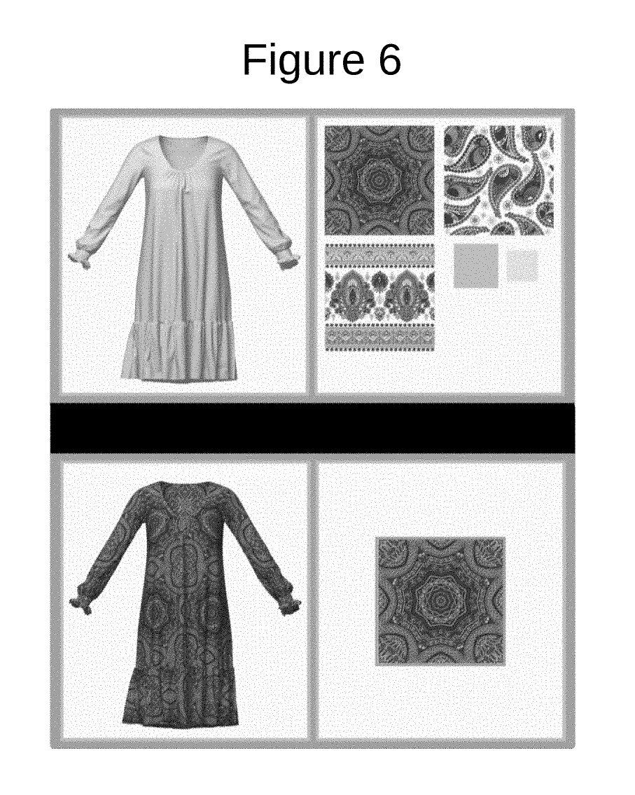

With reference to FIG. 6, a sample screen presented by the development software 120 for adding patterns to the garment is shown. The designer may drag and drop garment patterns from the right side of the screen onto one or more parts of the garment to add the selected pattern to the garment.

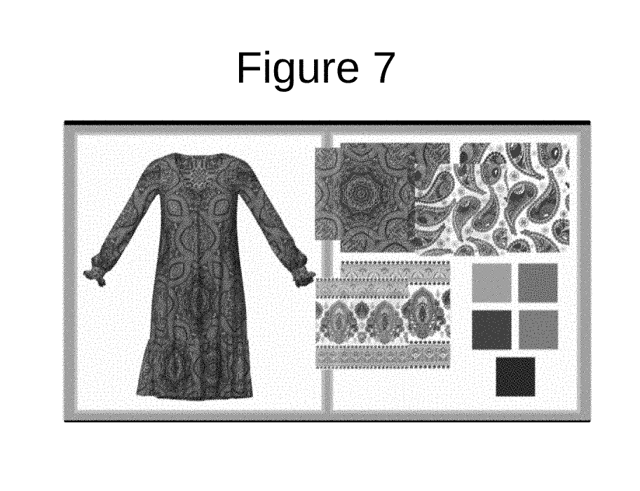

With reference to FIG. 7, a sample screen presented by the development software 120 for scaling patterns for the garment is shown. The development software 120 allows the user to drag to resize the patterns for the garment.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A server system for facilitating garment creation, comprising:
a processor and storage device configured to receive and store designed digital garment parts for selection and inclusion into a digital garment;
a designer interface accessible over a network configured to select and place two or more of the digital garment parts together to form a digital garment to store in the storage device; and
an online purchase system configured to access the storage device to select and purchase the digital garment from a plurality of available digital garments.

2. The server system of claim 1, wherein at least one or more of the digital garment parts are capable of being designed using the designer interface;

3. The server system of claim 1, wherein the server system is capable of receiving at least one or more of the digital garment parts by upload from a third-party design system.

4. The server system of claim 1, further including an interface for providing approval for the digital garment for manufacture or sale.

5. The server system of claim 1, wherein online purchase system is further configured to provide designers with the ability to purchase the digital garment parts to include in the digital garment.

6. The server system of claim 5, wherein the online purchase system is of a type selected from the group consisting of: a pay-per-part system or a subscription system.

7. A method for facilitating garment creation, comprising:
receiving and storing designed digital garment parts for selection and inclusion into a digital garment;
selecting and placing two or more of the digital garment parts together to form a digital garment to store in the storage device; and
providing an online purchase system configured to access the storage device to select and purchase the digital garment from a plurality of available digital garments.

8. The method of claim 7, wherein at least one or more of the digital garment parts are capable of being designed using a designer interface;

9. The method of claim 7, further comprising receiving at least one or more of the digital garment parts by upload from a third-party design system.

10. The method of claim 7, further providing approval for the garment for manufacture or sale.

11. The method of claim 7, further online purchase system is further configured to provide designers with the ability to purchase parts to include in the garment.

12. The method of claim 11, wherein the online purchase system is of a type selected from the group consisting of: a pay-per-part system or a subscription system.
